(19) United States
(12) Patent Application Publication
(10) Pub. No.: US 2026/0309827 A1
(43) Pub. Date: Oct. 8, 2026

(54) METHOD FOR DETERMINING A DIRECTION FROM WHICH AN EMERGENCY VEHICLE IS APPROACHING A VEHICLE

(71) Applicant: MERCEDES-BENZ GROUP AG, Stuttgart (DE)

(72) Inventors: Christian KOBETZ, Horb (DE); Konstantin FICHTNER, Sindelfingen (DE)

(21) Appl. No.: 19/482,832

(22) PCT Filed: Apr. 18, 2024
(86) PCT No.: PCT/EP2024/060494

§ 371 Date: Nov. 10, 2025

(30) Foreign Application Priority Data
May 11, 2023 (DE) 10 2023 001 906.2

(51) Int. Cl. G01S 3/808; G01S 7/52; G01S 15/86; G01S 15/89; G08G 1/01; G08G 1/056; G08G 1/09

(52) U.S. Cl. CPC G01S 3/8083; G01S 7/52004; G01S 15/86; G01S 15/89; G08G 1/0137; G08G 1/056; G08G 1/091

(57) ABSTRACT

A direction of an emergency vehicle, emitting a special acoustic signal, approaching a vehicle is determined using a microphone arrangement having microphones arranged spaced apart from each other on the vehicle. An acoustic test signal is emitted into the environment of the vehicle at each current position and reflections of the test signal occurring in the environment are detected by the microphone arrangement. A sound map is generated depending on the reflections and their amplitude and relative direction to the vehicle, which indicates the degree to which the emitted test signal is reflected back to the vehicle from different directions. Depending on the sound map generated for the current position, acoustic signals received by the microphones of the microphone arrangement, which are aligned in different directions, are weighted when determining the direction of the emergency vehicle.

### BACKGROUND AND SUMMARY OF THE INVENTION

Exemplary embodiments of the invention relate to a method for determining a direction from which an emergency vehicle is approaching a vehicle.

For automatic, in particular highly automatic or autonomously operated vehicles and for operating driver assistance systems, it is important to detect emergency vehicles found in a vehicle environment. This occurs, among other things, by means of acoustic detection of an emergency sound signal using external microphones arranged on the vehicle. This allows appropriate driving actions to be initiated when an emergency vehicle is detected, or, for example, an automated driving task to be terminated by handing over to a driver of the vehicle, or an emergency corridor to be formed in a complex situation as appropriate.

The not previously published German patent application with the file reference 10 2023 000 565.7 describes a method for determining a direction of reception of a special acoustic signal emitted by an emergency vehicle for a vehicle having a microphone arrangement. Sound-reflecting surfaces in an environment of the vehicle are identified on the basis of signals recorded by environmental sensors and information from a digital map, and are taken into account when determining the direction of reception.

The not previously published DE 10 2022 002 500 A1 describes a method for direction calibration of a microphone arranged on a vehicle by means of a reference noise, wherein the reference noise is generated by a sound source arranged in a predetermined position on the vehicle and recorded by the microphones.

A method for supporting a driver of a vehicle in perceiving external noises is known from DE 10 2020 213 185 A1, in which it is provided that audio signals are detected using multiple external microphones provided on the vehicle, frequency ranges of sirens from emergency vehicles are filtered out of the audio signals, and a direction of movement of an audio source emitting the filtered audio signals is determined.

A detection mechanism for detecting an acoustic signal in an environment of a vehicle is known from DE 10 2018 207 758 A1, wherein the detection mechanism has multiple external microphones which are arranged above a cab of the vehicle.

A method for operating a driver assistance system is known from DE 10 2018 217 891 A1, in which acoustic emergency signals of an emergency vehicle are detected by means of multiple microphones and depending on these, information is output to a driver or a driving intervention is carried out.

Exemplary embodiments of the invention are directed to a novel method for determining a direction from which an emergency vehicle is approaching a vehicle.

In a method for determining an emergency vehicle direction, from which an emergency vehicle is approaching a vehicle, a special acoustic signal emitted by the emergency vehicle is detected by means of a microphone arrangement having a plurality of microphones spaced apart from one another on the vehicle. A direction of reception of the special signal is determined by evaluating the acoustic signals received by the microphone arrangement, taking into account the sound-reflecting surfaces present in the environment of the vehicle, and the direction of the emergency vehicle is determined on the basis of the direction of the reception.

In accordance with the invention, the microphone arrangement is calibrated in a location-specific manner for each current position of the vehicle, in that
an acoustic test signal is emitted into the environment of the vehicle at each current position,
reflections of the test signal occurring in the environment are detected by means of the microphone arrangement,
a sound map is generated depending on the reflections and their amplitude and relative direction to the vehicle, which indicates the degree to which the emitted test signal is reflected back to the vehicle from different directions, and
depending on the sound map generated for the current position, acoustic signals received by the microphones of the microphone arrangement, which are aligned in different directions, are weighted when determining the direction of the emergency vehicle.

A sound map, which can also be referred to as a noise map, is understood in the present case in particular to mean a map representation in which an acoustic reflection behavior in an environment of the vehicle is represented.

By means of the present method, sound-reflecting objects can be detected in a simple and reliable manner by means of reflections in an environment of the vehicle, in particular an automatic, for example highly automatic or autonomously operable vehicle. By taking these sound-reflecting objects into account when acoustically detecting the environment of the vehicle, it is possible to detect the special signal of an emergency vehicle with particular accuracy and, as a result, to determine the direction of the emergency vehicle with particular accuracy, while significantly reducing the number of false-positive detections due to reflections. This results in particularly reliable detection of emergency vehicles, in particular in urban traffic scenarios with a high number of acoustically reflective objects. This in turn leads to improved situation recognition and improved system response in the vehicle, for example, to transfer a driving task from an automated driving function to a driver to ensure that the vehicle drives appropriately for the situation, for example forming an emergency corridor. This means that automated driving functions can be designed to be particularly safe, enabling regulatory requirements for automated driving to be implemented particularly safely.

According to a possible embodiment of the method, the sound map is used to map the reflection properties of the environment of the vehicle in a 360° range around the vehicle. This enables comprehensive mapping of reflection properties in the environment of the vehicle, allowing for precise, high-resolution detection of the direction of the emergency vehicle in all directions around the vehicle.

According to a further possible embodiment of the method, a high-frequency noise, in particular a clicking noise, is emitted as an acoustic test signal. Such a noise is particularly suitable as a test signal.

According to a further possible embodiment of the method, the reflections are detected by means of at least four microphones arranged on four corner or four sides of the vehicle. This enables a simple design of the microphone arrangement while simultaneously having a large coverage of a detection area.

According to a further possible embodiment of the method, the weighting is used to adjust a volume of a signal emitted by the respective microphone such that noises detected from areas in which reflective objects have been detected are given less consideration when determining the direction of the emergency vehicle.

According to a further possible embodiment of the method, the transit times between the emission of the test signal and the reception of the reflections are determined, and these transit times are used to calculate the distances between the sound-reflecting surfaces and the respective microphone. This means that the distances to the sound-reflecting surfaces can also be determined without the need for additional hardware.

According to a further possible embodiment of the method, the generated sound map is made plausible using data from the environment, which is detected by at least one camera, at least one lidar and/or at least one radar. In this way, a reliability when determining the direction of the emergency vehicle can be further improved.

Exemplary embodiments of the invention are explained in more detail below using the drawings.

### BRIEF DESCRIPTION OF THE DRAWING FIGURES

Here are shown:

FIG. 1 schematically, a course of a method for determining a direction of an emergency vehicle from which an emergency vehicle is approaching a vehicle,

FIG. 2 schematically, a plan view of a traffic situation during an emission of an acoustic test signal by a vehicle,

FIG. 3 schematically, a plan view of the traffic situation according to FIG. 2 and a sound map, and

FIG. 4 schematically, a plan view of the traffic situation and the sound map according to FIG. 3 during a determination of the correction values for weighting acoustic signals received by microphones in a microphone arrangement.

Parts corresponding to each other are provided with the same reference numerals in all figures.

### DETAILED DESCRIPTION

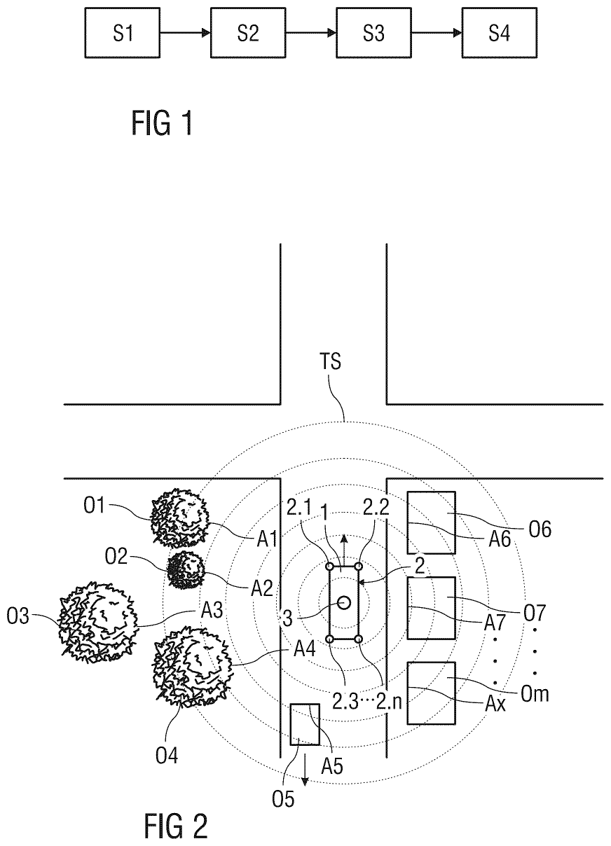

FIG. 1 depicts a course of a possible exemplary embodiment of a method for determining a direction of an emergency vehicle from which an emergency vehicle approaches a vehicle 1 depicted in more detail in FIGS. 2 to 4.

The vehicle 1 is in particular designed for automatic, for example highly automatic or autonomous driving operation. During such an automatic driving operation, it is important to safely detect emergency vehicles found in an environment of the vehicle 1 in order to be able to react adequately to these.

For such a detection, it is provided that a direction of an emergency vehicle from which the emergency vehicle approaches the vehicle 1 is determined. This occurs by a special acoustic signal emitted by the emergency vehicle being detected by means of a microphone arrangement 2, which is also depicted in more detail in FIGS. 2 to 4. For this purpose, the microphone arrangement 2 comprises a plurality of microphones 2.1 to 2.n.

In an evaluation of acoustic signals received by the microphone arrangement 2, a direction of reception of the special signal is then determined, taking into account sound-reflecting surfaces A1 to Ax present in the environment of the vehicle 1, and the direction of the emergency vehicle is determined on the basis of the direction of reception.

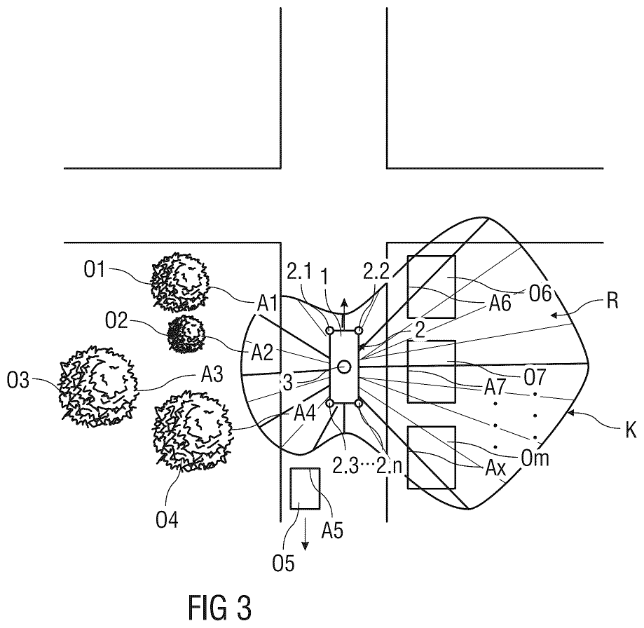

To determine the sound-reflecting surfaces A1 to Ax and their acoustic reflection behavior, in a method step S1, an acoustic test signal TS is emitted into the environment of the vehicle 1 at a current position by means of at least one external loudspeaker 3 of the vehicle 1, which is also depicted in more detail in FIGS. 2 to 3.

Reflections R of the test signal TS occurring in the environment on the sound-reflecting surfaces A1 to Ax are detected in a further method step S2 by means of the microphone arrangement.

In a further method step S3, a sound map K is generated depending on the reflections R as well as their amplitude and relative direction to the vehicle 1, which indicates the degree to which the emitted test signal TS is reflected back to the vehicle 1 from different directions.

Subsequently, in a further method step S4, depending on the sound map K generated for the current position, the acoustic signals received by the microphones 2.1 to 2.n of the microphone arrangement 2, which are aligned in different directions, are weighted when determining the direction of the emergency vehicle. Thus the microphone arrangement 2 is calibrated in a location-specific manner for each current position of the vehicle 1.

FIG. 2 shows a plan view of a traffic situation during an emission of the acoustic test signal TS by the external loudspeaker 3 of the vehicle 1 and thus visualizes a possible embodiment of the method step S1 described in FIG. 1.

In the traffic situation, the vehicle 1 is located on a roadway and moves towards a crossroads. On the left of the vehicle 1, multiple objects O1 to O4 formed as trees are located. Diagonally to the left behind the vehicle 1, an object O5 formed as a vehicle is located and to the right of the vehicle 1, multiple objects O6 to Om formed as buildings are located.

In particular during a driving operation of the vehicle 1, the acoustic test signal TS, for example a high-frequency noise, in particular a clicking noise, is emitted into the environment of the vehicle 1 at the current position by means of the external loudspeaker 3 of the vehicle 1.

This test signal TS is reflected on sound-reflecting surfaces A1 to Ax of the objects O1 to Om, wherein the objects O1 to O4, which are formed as trees, have average attenuation and reflection properties, and the objects O6 to Om, which are formed as buildings, have high reflection properties. In front of the vehicle 1 in the direction of travel, there is a free field with low reflectivity. The object O5, which is located to the left behind the vehicle 1 and is also formed as a vehicle, has high reflectivity, but due to its small size, it only represents a medium reflection R.

The reflections R of the test signal TS occurring on the sound-reflecting surfaces A1 to Ax are then detected by means of the microphone arrangement 2, for example by means of at least four microphones 2.1 to 2.n arranged on four corner or four sides of the vehicle 1.

In accordance with these reflection properties of the objects O1 to Om, a sound map K is generated, as depicted in FIG. 3, depending on the reflections R and their amplitude and relative direction to the vehicle 1, which indicates the degree to which the transmitted test signal TS is reflected back from different directions to the vehicle 1. Reflections R of the test signal TS originating from the objects O1 to Om with high reflectivity have a higher amplitude than the reflections R originating from the objects O1 to Om with low reflectivity.

In a possible embodiment, the transit times occurring between the emission of the test signal TS and the reception of the reflections R can additionally be determined, and the distances between the sound-reflecting surfaces A1 to Ax of the objects O1 to Om and the respective microphone 2.1 to 2.n can be determined on the basis of the transit times.

As can be seen from FIG. 3, the sound map K is used to map the reflection properties of the environment of the vehicle 1 in a 360° range around the vehicle 1, wherein the reflections R are represented in a directionally resolved manner and are represented with a higher amplitude for objects O1 to Om with high reflectivity and with a lower amplitude for objects O1 to Om with low reflectivity.

This means that it is detected whether reflections R occur in a direction, wherein the directions can be divided into different reflection levels in a possible embodiment relative to the vehicle 1, for example “in front”, “behind”, “left” and “right”. The reflection levels are, for example, “no reflection”, “low reflection”, “medium reflection” and “high reflection”.

In a further possible embodiment, the generated sound map K is made plausible by means of environment data, which is detected by means of at least one camera, at least one lidar and/or at least one radar. If a camera, a radar and/or a lidar are available with a 360° detection, a 360° sound map can also be created using these sensors. This can be determined in advance in tests to determine the influence on the acoustic reflections R and then also to create a 360° sound map with the reflection levels.

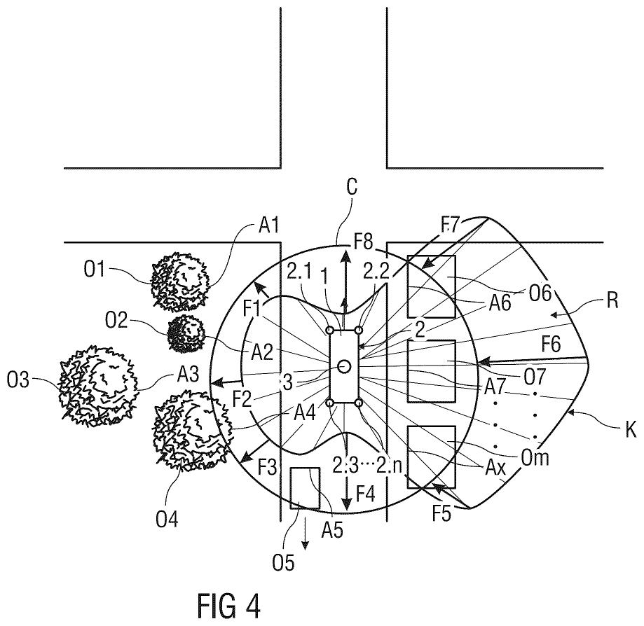

The weighting of the acoustic signals received by the microphones 2.1 to 2.n of the microphone arrangement 2, which are aligned in different directions, carried out in the method step S4 depending on the sound map K generated for the current position when determining the direction of the emergency vehicle, is depicted in FIG. 4. In particular, the weighting is used to adjust the volume of a signal output by the respective microphone 2.1 to 2.n.

This means that, based on the sound map K with the reflection levels, the signals detected when recognizing the direction of the emergency vehicle using the microphones 2.1 to 2.n are calculated using correction factors F1 to F8. These correction factors F1 to F8, which are represented as arrows, are adapted to the various reflection levels in tests, for example. This significantly improves the performance of direction detection, as direction detection is improved by taking into account the objects O1 to Om and their reflectivity, particularly in urban traffic scenarios.

If the microphones 2.1 to 2.n were not calibrated using the correction factors F1 to F8, a special signal from an emergency vehicle, for example, would be perceived more strongly from the right and too weakly from the front or rear due to the high reflectivity of the objects O6 to Om, which are designed as buildings.

In a free and thus for the acoustic detection by means of the microphone arrangement 2 optimal environment, all microphones 2.1 to 2.n would have no influence in any direction, such that the detected reflections R would be evenly distributed in amplitude in all directions. This is represented by a circle C, which extends in a range of 360° around the vehicle 1.

The determination of the correction factors F1 to F8 and the calibration of the microphones 2.1 to 2.n occur depending on deviations of the sound map K from this circle C. Thus an average value of the amplitudes of the reflections R detected by means of all microphones 2.1 to 2.n serves to determine a radius of the circle C and the normalization.

This means that the areas to the right of the vehicle 1 are reduced or weakened due to the high amplitudes of the reflections R resulting from the high reflectivity, with correction factors F5 to F7 having a value of less than “1”, for example “0.5”.

The areas in front of and behind the vehicle 1 are increased or strengthened due to the low amplitudes of the reflections R resulting from the low reflectivity, with correction factors F4, F8 having a value of more than “1”, for example “2”.

The areas to the left of the vehicle 1 are increased or strengthened less due to the average amplitudes of the reflections R resulting from the average reflectivity, with correction factors F1 to F3 having a value of more than “1”, for example “1.25”.

Thus 360° correction factors F1 to F8 are formed, which are used during the calibration of the microphones 2.1 to 2.n. The environment detection of the microphones 2.1 to 2.n is then switched to an “active” status.

If an acoustic special signal of an emergency vehicle is detected, the microphones 2.1 to 2.n are influenced less by the environment.

In the following example, an application of the described method is clarified. By way of example, an emergency vehicle, for example a fire engine, approaches the vehicle 1 from the right. An environment of the vehicle 1 is free in all directions, but to the left there is a concrete boundary.

Without the concrete boundary being present, the direction detection would clearly assign the received special signal to the right and thus correctly. With the concrete boundary, the direction detection would detect erroneous and false-positive reflections R, which would lead to an erroneous direction assignment of the emergency vehicle to the left due to the reflections R on the concrete boundary. By creating the sound map K according to the above description, it is known that there are no or only minor reflections R in front of, behind and to the right of the vehicle 1, and that the reflections R are high to the left of the vehicle 1. The sound map K can now be used to weight the microphones 2.1 to 2.n with the correction factors F1 to F8 such that a volume of the microphones 2.1 to 2.n facing the left area of the vehicle 1 is reduced by means of at least one correction factor F1 to F8. Thus acoustic signals from the right are taken into account to a greater extent and the algorithm would detect the direction of the emergency vehicle more reliably as being to the right, i.e., correctly.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-7. (canceled)

8. A method for a vehicle having a microphone arrangement, the method comprising:
calibrating the microphone arrangement, which comprises a plurality of microphones arranged spaced apart from each other on the vehicle and are aligned in different directions, in a location-specific manner for each current position of the vehicle by
emitting an acoustic test signal into an environment of the vehicle at the each current position;
receiving, by the microphone arrangement, reflections of the acoustic test signal occurring in the environment;
generating a sound map depending on the reflections, amplitude of the reflections, and relative direction of the reflections to the vehicle, which indicates a degree to which the emitted acoustic test signal is reflected back to the vehicle from different directions; and
detecting, by a microphone arrangement of a vehicle, a special acoustic signal emitted by an emergency vehicle; and
determining a direction from which the emergency vehicle from is approaching the vehicle using the special acoustic signal received by the microphones of the microphone arrangement by weighting the special acoustic signal received by each of the microphones of the microphone arrangement using the sound map.

9. The method of claim 8, wherein the sound map maps reflection properties of the environment of the vehicle in a range of 360° around the vehicle.

10. The method of claim 8, wherein the acoustic test signal is a high-frequency noise.

11. The method of claim 8, wherein the microphones of the microphone arrangement comprise at least four microphones arranged on four corners or four sides of the vehicle.

12. The method of claim 8, wherein the weighting is used to adjust a volume of a signal output by a respective microphone of the microphone arrangement.

13. The method of claim 8, wherein transit times between the emitting of the acoustic test signal and the receiving of the reflections is determined and distances between sound-reflecting surfaces and a respective microphone of the microphone arrangement is determined based on the transit times.

14. The method of claim 8, wherein the generated sound map is confirmed using data from the environment detected by at least one camera, at least one lidar or at least one radar.
